(19) United States
(12) Patent Application Publication
(10) Pub. No.: US 2021/0113944 A1
(43) Pub. Date: Apr. 22, 2021

(54) DEPTH FILTER AND FILTER CARTRIDGE

(71) Applicant: ROKI TECHNO CO., LTD., Tokyo (JP)

(72) Inventor: Tomoya SATO, Tokyo (JP)

(21) Appl. No.: 16/971,776

(22) PCT Filed: Feb. 26, 2018
(86) PCT No.: PCT/JP2018/006925

§ 371 Date: Aug. 21, 2020

(51) Int. Cl. B01D 29/33; B01D 39/08; B01D 35/30; B32B 1/08; B32B 5/02; B32B 5/26

(52) U.S. Cl. CPC B01D 29/336; B01D 39/08; B01D 35/30; B32B 1/08; B01D 2239/065; B32B 5/26; B01D 2201/182; B01D 2239/0618; B32B 5/022

(57) ABSTRACT

The depth filter includes a first filter layer having a cylindrical shape, and a second filter layer having a cylindrical shape. The second filter layer is arranged on the inner side of the first filter layer, and the second filter layer has a mesh coarseness that is the same as or less than the mesh coarseness of the first filter layer. The depth filter also includes a space layer provided between the first filter layer and the second filter layer. In the space layer, the fluid resistance between a front side and a rear side of the space layer is substantially zero. A filter cartridge including a filter cover and the depth filter arranged inside the filter cover is also described.

### TECHNICAL FIELD

This invention relates to a depth filter, and a filter cartridge which includes the depth filter.

### BACKGROUND ART

A depth filter is required to capture particles of a planned size included in a fluid that is a filtration object, for a predetermined period. Accordingly, accompanying the passage of the operating time, a pressure loss in the flow of fluid passing through a depth filter increases due to captured particles accumulating in the filter material. Therefore, to ensure the flow of fluid, it is necessary to increase the total pressure of the fluid according to the pressure loss, and consequently the total pressure increases with time when using a depth filter.

A conventional depth filter 31 will be described referring to FIG. 8 and FIG. 9. In general, the depth filter 31 is housed inside a filter housing 20. FIG. 8 is a view illustrating the filter housing 20 and a filter cartridge. FIG. 9 illustrates a cross section Y-Y of FIG. 8. The filter housing 20 has a flow path inlet 21 and a flow path outlet 22. The flow path inlet 21 of the filter housing 20 is joined to a pump (not illustrated) that promotes the flow of the fluid to be filtered, and the fluid to be filtered is introduced into the filter housing 20 by the pump. The depth filter 31 is detachably housed inside a filter cover 32 made of, for example, resin, and functions as a filter cartridge. The fluid introduced into the filter housing 20 flows via the outer peripheral surface of the depth filter 31 to pass through the depth filter 31 from the outer peripheral surface of the filter cover 32 which is the primary side of the depth filter 31, and flows out to a central flow path 33 of the filter which is the secondary side of the depth filter 31. The fluid that flowed out to the central flow path 33 of the filter of the depth filter 31 is discharged to outside from the flow path outlet 22.

The depth filter 31 is formed of one or more cylindrical filter layers 34 for capturing particles that are impurities. The fluid typically flows from the outer side in the radial direction of the cylindrical filter layer 34 toward the inner side. FIG. 9 illustrates an example of a depth filter 31 having a filter layer 34 with two layers which are arranged so that a second filter layer 34b on the secondary side (downstream side of the flow) contacts the inner side of a first filter layer 34a on the primary side (upstream side of the flow). With regard to the coarseness of the mesh of the respective filter layers of the filter layer 34, the coarseness of the mesh is the same between the filter layer on the primary side and the filter layer on the secondary side which are adjacent to each other, or is set so that the mesh of the filter layer on the secondary side is finer than the mesh of the filter layer on the primary side. That is, in the case of the depth filter 31 illustrated in FIG. 9, the coarseness of the mesh of the first filter layer 34a and the coarseness of the mesh of the second filter layer 34b are the same, or the mesh of the second filter layer 34b is set to be finer than the mesh of the first filter layer 34a. In the depth filter 31 in which a nonwoven fabric is selected as the material of the filter layer 34, the depth filter 31 is susceptible to the influence of an increase in the total pressure, and even particles which the filter layer 34 had succeeded in capturing are swept away to the secondary side of the filter layer 34 as a result of the total pressure increasing, and consequently the capturing accuracy decreases.

### SUMMARY OF INVENTION

### Technical Problem

The forms of an increase in total pressure in the depth filter 31 include a form in which, during steady operation, there is a pressure increase accompanying inherent pulsation of the pump that promotes the flow of fluid, and a form in which there is a pressure increase for the purpose of compensating for a pressure loss that arises over time such as in the case of a clogged mesh in the filter layer 34 of the depth filter 31. Further, the cause of an increase in total pressure during unsteady operation is an increase in the secondary side pressure of the pump when regulating the flow rate of the fluid or when activating a fluid line. In the conventional depth filter 31, the pressure increase in these cases directly leads to a direct increase in pressure inside the depth filter 31, thus leading to a decrease in the capturing accuracy.

### Solution to Problem

One aspect of the present invention is a depth filter including a first filter layer having cylindrical shape, a second filter layer having a cylindrical shape, the second filter layer arranged on an inner side of the first filter layer, the second filter layer having a mesh coarseness same as or less than a mesh coarseness of the first filter layer, and a space layer provided between the first filter layer and the second filter layer, wherein in the space layer, fluid resistance between a front side and a rear side of the space layer is substantially zero.

Another aspect of the present invention is a filter cartridge including a filter cover, and a depth filter arranged inside the filter cover, the depth filter including a first filter layer having a cylindrical shape, a second filter layer having a cylindrical shape, the second filter layer arranged on an inner side of the first filter layer, the second filter layer having a mesh coarseness same as or less than a mesh coarseness of the first filter layer, and a space layer provided between the first filter layer and the second filter layer, wherein in the space layer, fluid resistance between a front side and a rear side of the space layer is substantially zero.

### Advantageous Effects of Invention

By means of the configuration of the present invention, the influence of pressure in the depth filter at a time of a pressure increase can be reduced, and the capturing accuracy can be maintained.

### BRIEF DESCRIPTION OF DRAWINGS

FIG. 1 is an external view of a filter cartridge of the present invention.

FIG. 2 is a cross-sectional view illustrating a layer structure of a depth filter of the present invention at the location of a cross section X-X in FIG. 1, illustrating Embodiment 1.

FIG. 3 is a cross-sectional view illustrating a layer structure of the depth filter of the present invention at the location of the cross section X-X in FIG. 1, illustrating Embodiment 2.

FIG. 4 is a cross-sectional view illustrating a layer structure of the depth filter of the present invention at the location of the cross section X-X in FIG. 1, illustrating Embodiment 3.

FIG. 5 is a cross-sectional view illustrating a layer structure of the depth filter of the present invention at the location of the cross section X-X in FIG. 1, illustrating Embodiment 4.

FIG. 6 is a cross-sectional view illustrating a layer structure of the depth filter of the present invention at the location of the cross section X-X in FIG. 1, illustrating Embodiment 5.

FIG. 7 is a view illustrating an example in which three layers are adopted as the number of filters with respect to Embodiment 5.

FIG. 8 is an external view of a conventional filter cartridge.

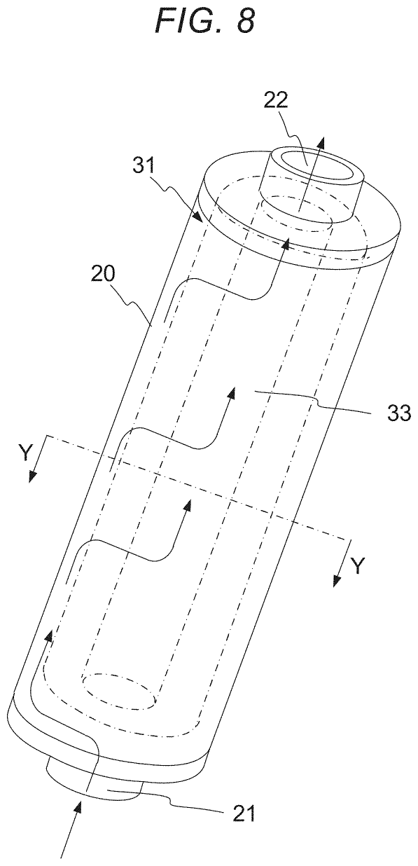

FIG. 9 is a cross-sectional view illustrating the layer structure of a conventional depth filter at the location of a cross section Y-Y in FIG. 8.

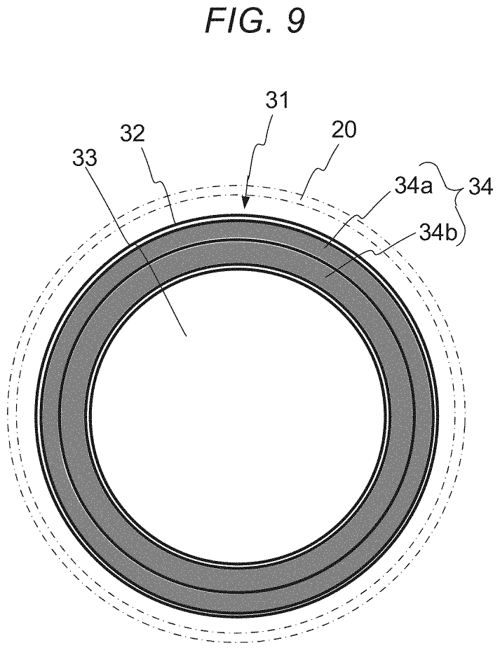

### DESCRIPTION OF EMBODIMENTS

### Embodiment 1

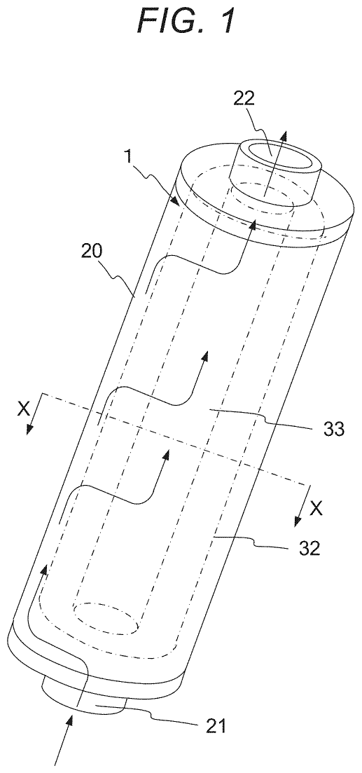

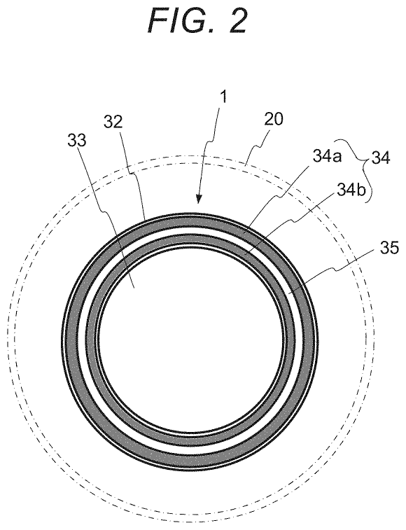

Hereunder, a depth filter 1 of Embodiment 1 of the present invention as well as a filter cartridge equipped with the depth filter 1 are described with reference to FIG. 1 and FIG. 2. FIG. 1 illustrates a filter cartridge which includes the depth filter 1 therein. FIG. 2 is a cross-sectional view that illustrates the structure of respective layers of the depth filter 1 at a cross section X-X in FIG. 1.

The filter cartridge includes a filter cover 32, and the depth filter 1 arranged inside the filter cover 32. The filter cartridge is detachably housed inside a filter housing 20 and used. The filter housing 20 has a flow path inlet 21 and a flow path outlet 22. The flow path inlet 21 of the filter housing 20 is joined to a pump (not illustrated) that promotes the flow of a fluid to be filtered, and the fluid to be filtered is introduced into the filter housing 20 by the pump. The introduced fluid flows via the outer peripheral surface of the depth filter 1 to pass through the depth filter 1 from the outer peripheral surface which is the primary side (upstream side of the flow) of the depth filter 1, and flows out to a central flow path 33 of the filter which is the secondary side (downstream side of the flow) of the filter. The fluid that flows out to the central flow path 33 of the filter is discharged to outside from the flow path outlet 22. The fluid typically flows toward the inner side from the outer side in the radial direction of the cylindrical filter layer 34.

The depth filter 1 is formed of a plurality of cylindrical filter layers 34 for capturing particles that are impurities. In Embodiment 1, in FIG. 2 an example is illustrated of the depth filter 1 having a filter layer 34 with two layers that includes a cylindrical filter layer 34a (first filter layer) on the primary side and a cylindrical second filter layer 34b on the secondary side arranged on the inner side of the first filter layer 34a in the cylindrical radial direction of the filter layer 34. The mesh coarseness of the respective filter layers is set so that the mesh coarseness is the same between the first filter layer 34a on the primary side and the second filter layer 34b on the secondary side that are arranged adjacent to each other in the cylindrical radial direction of the filter layer 34, or so that the mesh of the second filter layer 34b on the secondary side is finer than the mesh of the first filter layer 34a on the primary side. That is, in the case of the depth filter 1 illustrated in FIG. 2, the mesh coarseness is set to be the same between the first filter layer 34a and the second filter layer 34b, or so that the mesh of the second filter layer 34b is finer than the mesh of the first filter layer 34a. The sizes of these meshes can be selected according to the design of the depth filter 1. Typically, the size of the mesh of the first filter layer 34a on the primary side is set with the objective of capturing and rectifying large particles, and the size of the mesh of the second filter layer 34b on the secondary side is set with the objective of capturing small particles. The outer side of the first filter layer 34a serves as a fluid inflow surface, and connects to the flow path inlet 21. The inner side of the second filter layer 34b serves as a fluid discharge flow path, and connects to the flow path outlet 22.

A space layer 35 is provided between the first filter layer 34a that is the primary-side filter layer and the second filter layer 34b that is the secondary-side filter layer. The space layer 35, for example, can be provided as a gap formed so that a predetermined distance is secured by means of a spacer (not illustrated) or the like between the first filter layer 34a and the second filter layer 34b and so as to have a predetermined volume. Since the space layer 35 is a gap, the fluid resistance between the front side and rear side of the space layer 35 is zero, that is, there is no fluid resistance.

Alternatively, the space layer 35 can be provided as a layer formed of a fiber in which fluid resistance does not arise between the front side and the rear side of the space layer 35, that is, a fiber in which the fluid resistance between the front side and the rear side of the fiber is substantially zero. For example, the space layer 35 can be formed as a nonwoven fabric in which the mesh is coarse and large and which has a large number of micro-interspaces communicating between the front side and the rear side, and there is a large cross-sectional area between the front side and the rear side of the micro-interspaces. In this case, the phrase “fluid resistance does not arise” means that the micro-interspaces that are present in the fiber are large, so that when fluid flows through the fiber, the fluid flows through the micro-interspaces and no resistance arises in the flow at that time. The fiber layer of the space layer 35 serves as a spacer which does not generate fluid resistance and which is not liable to cause volume fluctuations. Thus, the space layer 35 at which a predetermined volume is secured is formed between the first filter layer 34a and the second filter layer 34b.

Next, the effect of providing the space layer 35 will be described. When pressure fluctuations arise accompanying a pressure increase that accompanies inherent pulsation of a pump promoting the flow of fluid, the space layer 35 serves as a buffer that reduces the pressure fluctuations. That is, when an inherent pressure fluctuation of the pump is taken as an input signal, the space layer 35 functions as a signal filter, and an effect is produced such that pressure fluctuations applied to the first filter layer 34a are attenuated by the space layer 35. In this regard, when a pressure sensor was disposed in the first filter layer 34a and another pressure sensor was disposed in the second filter layer 34b, it was found that when the detected pressure at the pressure sensor disposed in the first filter layer 34a was a primary side pressure of 127.5 kilopascals ±4.5 kilopascals, the detected pressure at the pressure sensor disposed in the second filter layer 34b was 85.5 kilopascals ±0.25 kilopascals. As demonstrated by this result, because of the presence of the space layer 35, the pressure fluctuation range was reduced from ±4.5 kilopascals to ±0.25 kilopascals which meant that the pressure fluctuation range was suppressed to around 5.6 percent, and thus a decrease of 94 percent in the fluctuation range was observed. It is possible to adjust the amount of attenuation in the pressure fluctuation amount by adjusting the thickness (width) of the space layer 35, that is, by adjusting the volume of the space layer 35.

### Embodiment 2

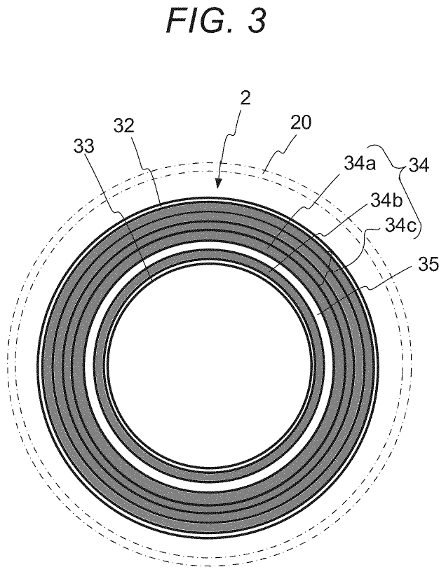

Next, a depth filter 2 of Embodiment 2 of the present invention and a filter cartridge equipped with the depth filter 2 are described with reference to FIG. 1 and FIG. 3. FIG. 3 is a cross-sectional view that illustrates the structure of the respective layers of the depth filter 2 at the cross section X-X in FIG. 1. In this case, the depth filter 1 illustrated in FIG. 1 is replaced with the depth filter 2 of Embodiment 2. In this embodiment also, the filter cartridge includes the filter cover 32, and the depth filter 2 arranged inside the filter cover 32. As in Embodiment 1, the filter cartridge is housed inside the filter housing 20 and used. The portion in Embodiment 2 that differs from Embodiment 1 is described hereunder.

Embodiment 2 differs from Embodiment 1 in the respect that one or more filter layers 34c having a cylindrical shape are further provided on the outer side in the radial direction of the cylindrically shaped cross section of the first filter layer 34a of Embodiment 1. The one or more filter layers 34c are arranged to contact each other along the radial direction of the cylindrically shaped cross section of the respective layers. The number of layers constituting the filter layer 34c is not limited as long as the number is one or more. In this case, the relation between the mesh coarseness of the first filter layer 34a and the mesh coarseness of the second filter layer 34b is the same as in the case of Embodiment 1. In addition, with respect to the mesh coarseness of the filter layers constituting the filter layer 34c, the mesh coarseness of adjacent filter layers is the same (equal) or decreases in the direction toward the inner side from the outer side in the radial direction of the cylindrically shaped cross sections of the layers. Further, with respect to the coarseness of the innermost layer of the filter layer 34c and the coarseness of the first filter layer 34a also, the mesh coarseness of adjacent filter layers is the same or decreases in the direction toward the inner side from the outer side in the radial direction of the cylindrically shaped cross sections of the layers. That is, with respect to the relation between the coarseness of the mesh of the respective layers from the outermost layer of the filter layer 34c to the second filter layer 34b, the coarseness of the mesh of adjacent filter layers is the same or decreases in the direction toward the inner side from the outer side in the radial direction of the cylindrically shaped cross sections of the layers.

As in the space layer 35 of Embodiment 1, the space layer 35 of Embodiment 2 is arranged between the first filter layer 34a and the second filter layer 34b. The internal structure of the space layer 35 is the same as in Embodiment 1. Therefore, from the viewpoint of the space layer 35, the one or more filter layers 34c having a cylindrical shape and the first filter layer 34a have the same structure as an integrated filter layer, and therefore, as in Embodiment 1, an effect is obtained such that the pulsation of pressure applied to the outermost layer of the filter layer 34c is attenuated by the space layer 35. As in Embodiment 1, it is possible to adjust the amount of attenuation of pressure pulsation fluctuations by the space layer 35 by adjusting the volume of the space layer 35.

### Embodiment 3

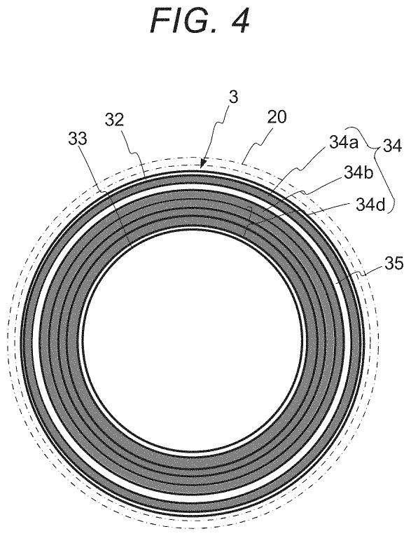

Next, a depth filter 3 of Embodiment 3 of the present invention and a filter cartridge equipped with the depth filter 3 are described with reference to FIG. 1 and FIG. 4. FIG. 4 is a cross-sectional view that illustrates the structure of the respective layers of the depth filter 3 at the cross section X-X in FIG. 1. In this case, the depth filter 1 illustrated in FIG. 1 is replaced with the depth filter 3 of Embodiment 3. In this embodiment also, the filter cartridge includes the filter cover 32, and the depth filter 3 arranged inside the filter cover 32. As in the foregoing embodiments, the filter cartridge is housed inside the filter housing 20 and used. The portion in Embodiment 3 that differs from the foregoing embodiments is described hereunder.

In Embodiment 2, the depth filter 2 further includes the one or more cylindrical filter layers 34c on the outer side in the radial direction of the cylindrically shaped cross section of the first filter layer 34a. Embodiment 3 differs from Embodiment 2 in the respect that, relative to Embodiment 1, the depth filter 3 further includes one or more filter layers 34d having a cylindrical shape on the inner side in the radial direction of the cylindrically shaped cross section of the second filter layer 34b. As in Embodiment 2, in Embodiment 3 the one or more filter layers 34d are arranged to contact each other along the radial direction of the cylindrically shaped cross section of the respective layers. The number of layers constituting the filter layer 34d is not limited as long as the number is one or more. Further, the relation between the mesh coarseness of the first filter layer 34a and the mesh coarseness of the second filter layer 34b is the same as in the case of Embodiment 1, and in addition, with respect to the coarseness of the mesh of the filter layers constituting the filter layer 34d, the coarseness of the mesh of adjacent filter layers is the same or decreases in the direction toward the inner side from the outer side in the radial direction of the cylindrically shaped cross sections of the layers. Furthermore, with respect to the coarseness of the outermost layer of the filter layer 34d and the coarseness of the second filter layer 34b also, the coarseness of the mesh of the adjacent filter layers is the same or decreases in the direction toward the inner side from the outer side in the radial direction of the cylindrically shaped cross sections of the layers. That is, with respect to the relation between the mesh coarseness of the respective layers from the second filter layer 34b to the innermost layer of the filter layer 34d, the mesh coarseness of adjacent filter layers is the same or decreases in the direction toward the inner side from the outer side in the radial direction of the cylindrically shaped cross sections of the respective layers.

As in the space layer 35 of Embodiment 1 and Embodiment 2, the space layer 35 of Embodiment 3 is arranged between the first filter layer 34a and the second filter layer 34b. The internal structure of the space layer 35 is the same as in Embodiment 1 and Embodiment 2. Therefore, from the viewpoint of the space layer 35, the second filter layer 34b and the filter layer 34d have the same structure as an integrated filter layer, and therefore, as in Embodiment 1 and Embodiment 2, an effect is obtained such that the pulsation of pressure applied to the first filter layer 34a is attenuated by the space layer 35. As in Embodiment 1 and Embodiment 2, it is possible to adjust the amount of attenuation of pressure pulsation fluctuations by the space layer 35 by adjusting the volume of the space layer 35.

### Embodiment 4

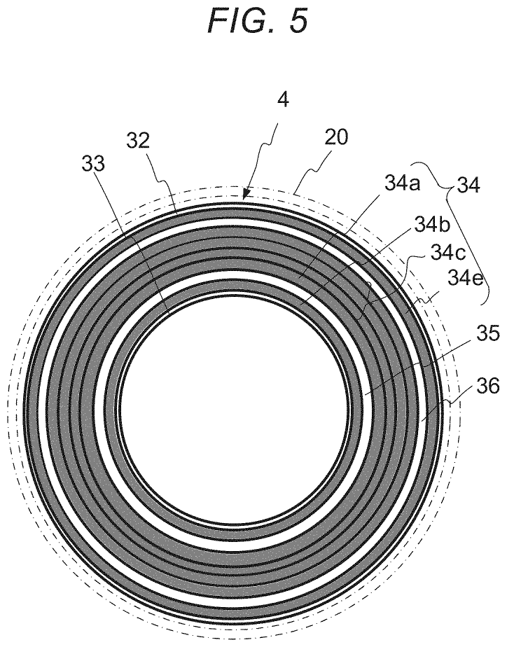

Next, a depth filter 4 of Embodiment 4 of the present invention and a filter cartridge equipped with the depth filter 4 are described with reference to FIG. 1 and FIG. 5. FIG. 5 is a cross-sectional view that illustrates the structure of the respective layers of the depth filter 4 at the cross section X-X in FIG. 1. In this embodiment also, the filter cartridge includes the filter cover 32, and the depth filter 4 arranged inside the filter cover 32. As in the foregoing embodiments, the filter cartridge is housed inside the filter housing 20 and used. The portion in Embodiment 4 that differs from the foregoing embodiments is described hereunder.

In Embodiment 2, the depth filter 2 further includes the one or more cylindrical filter layers 34c on the outer side in the radial direction of the cylindrically shaped cross section of the first filter layer 34a. Embodiment 4 differs from Embodiment 2 in the respect that a third filter layer 34e is further provided on the outer side of the outermost layer of the one or more filter layers 34c. Further, a space layer 36 is provided between the outermost layer of the filter layer 34c and the third filter layer 34e. With respect to the relation between the mesh coarseness of the respective layers from the third filter layer 34e that is the outermost layer of the filter layer 34 to the second filter layer 34b that is the innermost layer of the filter layer 34 via the filter layer 34c and the first filter layer 34a, the coarseness of the mesh of adjacent filter layers is the same or decreases in the direction toward the inner side from the outer side in the radial direction of the cylindrically shaped cross sections of the respective layers.

The internal structure of the space layer 35 and the space layer 36 of Embodiment 4 is the same as the internal structure of the space layer 35 of Embodiment 1, and as in the space layer 35, the space layer 36 produces an effect such that pulsations of the total pressure applied to the third filter layer 34e are attenuated by the space layer 36. Further, an effect is also produced such that the amount of fluctuation in pulsations of the pressure which are attenuated by the space layer 36 and propagated via the filter layer 34c and the first filter layer 34a are further attenuated by the downstream space layer 35. As in Embodiment 1 to Embodiment 3, it is possible to adjust the amount of attenuation of pressure pulsation fluctuations at the space layer 35 and the space layer 36 by adjusting the volume of the space layer 35 and the space layer 36.

### Embodiment 5

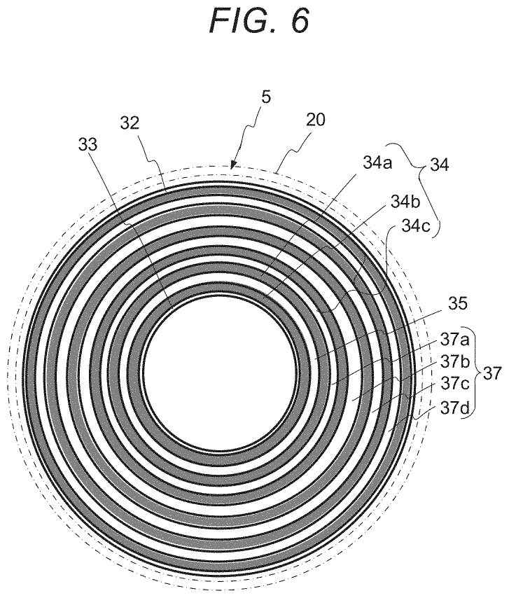

Next, a depth filter 5 of Embodiment 5 of the present invention and a filter cartridge equipped with the depth filter 5 are described with reference to FIG. 1 and FIG. 6. FIG. 6 is a cross-sectional view that illustrates the structure of the respective layers of the depth filter 5 at the cross section X-X in FIG. 1. In this embodiment also, the filter cartridge includes the filter cover 32, and the depth filter 5 that is arranged inside the filter cover 32. As in the foregoing embodiments, the filter cartridge is housed inside the filter housing 20 and used. The portion in Embodiment 5 that differs from Embodiment 2 is described hereunder.

Although Embodiment 5 is the same as Embodiment 2 in the respect that the filter layer 34 includes the filter layer 34c, Embodiment 5 differs from Embodiment 2 in the respect that space layers 37a, 37b, 37c and 37d are further provided between the respective filter layers constituting the filter layer 34c. The structure of the space layer 35 and the space layers 37a, 37b, 37c and 37d is the same as the structure of the space layer 35 of Embodiment 1. The number of layers constituting the filter layer 34c is not limited as long as the number is one or more. The number of the space layers 37a, 37b, 37c and 37d can be changed according to the number of layers constituting the filter layer 34c. With respect to the mesh coarseness of the first filter layer 34a, the second filter layer 34b and the filter layers constituting the filter layer 34c, as in Embodiment 2, the coarseness of the mesh of adjacent filter layers is the same or decreases in the direction toward the inner side from the outer side in the radial direction of the cylindrically shaped cross sections of the layers.

As in the space layer 35, the space layers 37a, 37b, 37c and 37d of Embodiment 5 produce an effect such that pulsations of the total pressure applied to the outermost layer of the filter layer 34c are attenuated by the space layers 37a, 37b, 37c and 37d and the space layer 35. Further, as in Embodiments 1 to 4, it is possible to adjust the amount of attenuation of pressure pulsation fluctuations by the space layer 35 and the space layers 37a, 37b, 37c and 37d by adjusting the volume of the space layer 35 and the space layers 37a, 37b, 37c and 37d.

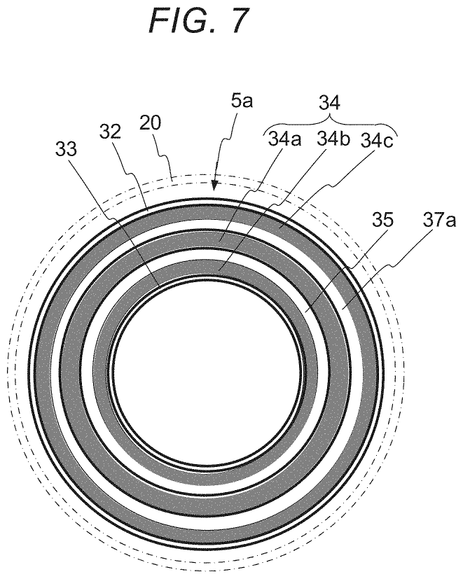

In this regard, we will discuss the amount of pressure attenuation in a case where the number of layers of the filter layer 34c was one, that is, in a case where the filter layer was composed of a total of three layers (the filter layer 34c as an outermost layer, the first filter layer 34a as a middle layer, and the second filter layer 34b as an innermost layer) (FIG. 7). When the total pressure applied to the filter layer 34c as the outermost layer constituting the filter layer 34 was 78.5 kilopascals ±2.5 kilopascals, the pressure applied to the filter layer 34a at the middle part was 77.1 kilopascals ±0.5 kilopascals. That is, the amount of fluctuation in the pulsations was attenuated by 80 percent. Further, the pressure at the second filter layer 34b as the innermost layer was 85.8 kilopascals ±0.15 kilopascals, and thus the amount of fluctuation in the pulsations was attenuated by a further 70 percent. That is, by providing the space layer 35 and the space layers 37a, 37b, 37c and 37d between the respective layers constituting the depth filter 5, an effect of attenuating the amount of fluctuation in pulsations is produced.

### REFERENCE SIGNS LIST

1, 2, 3, 4, 5, 31 depth filter

20 filter housing

32 filter cover

33 central flow path

34 filter layer

34a first filter layer

34b second filter layer

34c, 34d one or more filter layers

34e third filter layer

35, 36, 37 space layer

1. A depth filter comprising:
a first filter layer having a cylindrical shape;
a second filter layer having a cylindrical shape, the second filter layer arranged on an inner side of the first filter layer, the second filter layer having a mesh coarseness that is the same as or less than a mesh coarseness of the first filter layer; and
a space layer provided between the first filter layer and the second filter layer,
wherein in the space layer, fluid resistance between a front side and a rear side of the space layer is substantially zero.

2. The depth filter according to claim 1, wherein the space layer comprises a nonwoven fabric.

3. The depth filter according to claim 1, wherein the space layer is a gap having a predetermined width.

4. The depth filter according to claim 1, further comprising one or more filter layers having a cylindrical shape on an outer side of the first filter layer in a radial direction,
wherein a mesh coarseness of the first filter layer and the one or more filter layers in a direction toward the inner side from the outer side in the radial direction is equal or decreases.

5. The depth filter according to claim 4, further comprising:
a second space layer between an innermost layer of the one or more filter layers and the first filter layer, and
a third space layer between any two of the filter layers in the one or more filter layers.

6. The depth filter according to claim 4, further comprising:
a third filter layer on an outer side of an outermost layer of the one or more filter layers in a radial direction, the third filter layer having a mesh coarseness that is the same as or greater than a mesh coarseness of the outermost layer,
a second space layer between the outermost layer and the third filter layer.

7. The depth filter according to claim 6, further comprising one or more filter layers having a cylindrical shape on an inner side of the second filter layer in a radial direction,
wherein a mesh coarseness of the second filter layer and the one or more filter layers in a direction toward the inner side from the outer side in the radial direction is equal or decreases.

8. A filter cartridge comprising:
a filter cover detachably attachable to a filter housing; and
the depth filter according to claim 1 arranged inside the filter cover.

9. The filter cartridge according to claim 8, wherein the space layer comprises a nonwoven fabric.

10. The filter cartridge according to claim 8, wherein the space layer is a gap having a predetermined width.

11. The filter cartridge according to claim 8, further comprising one or more filter layers having a cylindrical shape on an outer side of the first filter layer in a radial direction,
wherein a mesh coarseness of the first filter layer and the one or more filter layers in a direction toward the inner side from the outer side in the radial direction is equal or decreases.

12. The filter cartridge according to claim 11, further comprising:
a second space layer between an innermost layer of the one or more filter layers and the first filter layer, and
a third space layer between any two of the filter layers in the one or more filter layers.

13. The filter cartridge according to claim 11, further comprising:
a third filter layer on an outer side of an outermost layer of the one or more filter layers in a radial direction, the third filter layer having a mesh coarseness that is the same as or greater than a mesh coarseness of the outermost layer,
a second space layer between the outermost layer and the third filter layer.

14. The filter cartridge according to claim 13, further comprising one or more filter layers having a cylindrical shape on an inner side of the second filter layer in a radial direction,
wherein a mesh coarseness of the second filter layer and of the one or more filter layers in a direction toward the inner side from the outer side in the radial direction is equal or decreases.

15. The depth filter according to claim 2, further comprising one or more filter layers having a cylindrical shape on an outer side of the first filter layer in a radial direction,
wherein a mesh coarseness of the first filter layer and the one or more filter layers in a direction toward the inner side from the outer side in the radial direction is equal or decreases.

16. The depth filter according to claim 3, further comprising one or more filter layers having a cylindrical shape on an outer side of the first filter layer in a radial direction,
wherein a mesh coarseness of the first filter layer and the one or more filter layers in a direction toward the inner side from the outer side in the radial direction is equal or decreases.

17. The filter cartridge according to claim 9, further comprising one or more filter layers having a cylindrical shape on an outer side of the first filter layer in a radial direction,
wherein a mesh coarseness of the first filter layer and the one or more filter layers in a direction toward the inner side from the outer side in the radial direction is equal or decreases.

18. The filter cartridge according to claim 10, further comprising one or more filter layers having a cylindrical shape on an outer side of the first filter layer in a radial direction,
wherein a mesh coarseness of the first filter layer and the one or more filter layers in a direction toward the inner side from the outer side in the radial direction is equal or decreases.
